(19) United States
(12) Patent Application Publication
(10) Pub. No.: US 2024/0006813 A1
(43) Pub. Date: Jan. 4, 2024

(54) Electrical Connector Assembly

(71) Applicant: TE Connectivity India Private Limited, Bangalore (IN)

(72) Inventor: Sachudhanandam Azhagiri, Bangalore (IN)

(73) Assignee: TE Connectivity India Private Limited, Bangalore (IN)

(21) Appl. No.: 18/344,257

(22) Filed: Jun. 29, 2023

(30) Foreign Application Priority Data
Jun. 30, 2022 (IN) 202241037885

(51) Int. Cl. H01R 13/629; H01R 13/639

(52) U.S. Cl. CPC H01R 13/62938; H01R 13/62916; H01R 13/639

(57) ABSTRACT

An electrical connector assembly includes a main housing with a guide receiving and guiding a slider, the slider having an oblique groove and a cam surface, a cover mountable to the main housing, and a lever hinged to the cover and having a cam counter surface. In a pre-lock condition, the cam counter surface is coupled with the cam surface to translate the slider upon tilting of the lever. The oblique groove cooperates with a mating element of a socket to move the electrical connector assembly into engagement with the socket upon translation of the slider. The cover is mountable to the main housing in a first and a reverse second orientation. The lever and the main housing have a poka yoke device establishing the pre-lock condition only when the lever is tilted into a predetermined initial position.

### CROSS-REFERENCE TO RELATED APPLICATION

This application claims the benefit of the filing date under 35 U.S.C. § 119(a)-(d) of Indian Patent Application No. 202241037885, filed on Jun. 30, 2022.

### FIELD OF THE INVENTION

The present invention relates to an electrical connector assembly and an electrical plug connection with such an electrical connector assembly.

### BACKGROUND

An electrical connector assembly usually has a housing and an actuation device for moving the housing into engagement with another housing, such that receptacle contacts of one of the housings are electrically connected to pluggable contacts of the other housing. Typically, one of the housings is fixed and, usually, the housing of the electrical connector assembly is the movable housing.

In order to save space, the moveable housing can be formed so that only a small portion of the moveable housing projects from the fixed housing when the housings are engaged. This configuration has caused the disengagement of the moveable housing from the fixed housing to be difficult. A problem also existed in that the plug connection typically has a large number of contact elements that exert a high normal contact force such that considerable force is required to plug-in and release the moveable housing from the fixed housing.

In order to resolve these problems, electrical connector assemblies have been provided with a lever and sliding device, wherein the sliding device is received in the movable housing and is displaceable in a direction transverse to a direction of engagement upon tilting of the lever. The sliding device is provided with oblique slots that engage with projections on the fixed housing. By displacement of the sliding device transversely to the direction of engagement, the movable housing is moved, in the engagement direction, toward the fixed housing.

These electrical connector assemblies can have a cover for dressing cables connected to the connector assembly, wherein the lever is typically hinged to the cover. Often, the location of the fixed housing requires that the cover dresses the cables in alternate orientations. Therefore, the cover and the movable housing have been designed such that the cover is mountable to the movable housing in alternate orientations.

When the cover is reversed to mount it to the housing in an alternate orientation, the lever will be reversed as well. That is, by reversing the cover, the lever will be pre-installed in its final position, which is opposite to its desired start position, the final position and the start position being the opposite end positions in the tilting direction. This can result in wrong loading of the sliding device upon tilting of the lever and wrong loading of the sliding device can damage the connector assembly.

### SUMMARY

An electrical connector assembly includes a main housing with a guide receiving and guiding a slider, the slider having an oblique groove and a cam surface, a cover mountable to the main housing, and a lever hinged to the cover and having a cam counter surface. In a pre-lock condition, the cam counter surface is coupled with the cam surface to translate the slider upon tilting of the lever. The oblique groove cooperates with a mating element of a socket to move the electrical connector assembly into engagement with the socket upon translation of the slider. The cover is mountable to the main housing in a first and a reverse second orientation. The lever and the main housing have a poka yoke device establishing the pre-lock condition only when the lever is tilted into a predetermined initial position.

### BRIEF DESCRIPTION OF THE DRAWINGS

The invention will be described in more detail in the following with reference to exemplary embodiments illustrated in the drawings, in which:

FIG. 1 is an exploded perspective view of an electrical connector assembly according to an embodiment;

FIG. 2a is a side view of the electrical connector assembly in a first state of dressing wires in a first lateral direction;

FIG. 2b is a side view of the electrical connector assembly in a second state of dressing wires in the first lateral direction;

FIG. 3a is a side view of the electrical connector assembly in a first state of dressing wires in a second lateral direction;

FIG. 3b is a side view of the electrical connector assembly in a second state of dressing wires in the second lateral direction;

FIG. 4a is a partially sectional side view of the electrical connector assembly in a first state arranged on a fixed socket;

FIG. 4b is a partially sectional side view of the electrical connector assembly in a second state arranged on the fixed socket;

FIG. 5 is a sectional end view of the electrical connector assembly, taken along line V-V of FIG. 4b;

FIG. 6a is a side view of mounting the cover to the main housing in a first orientation;

FIG. 6b is a side view of mounting the cover to the main housing in a second orientation;

FIG. 7a is a side view of an embodiment in which an initial position of a lever is incorrect and mounting of the cover to the main housing in a first orientation is prevented;

FIG. 7b is a side view of an embodiment in which the initial position of the lever is incorrect and mounting of the cover to the main housing in a second orientation is prevented;

FIG. 8 is a perspective view of the main housing; and

FIG. 9 is a perspective view of the electrical connector assembly with a sidewall of the housing next to the slider partially cut away.

### DETAILED DESCRIPTION OF THE EMBODIMENT(S)

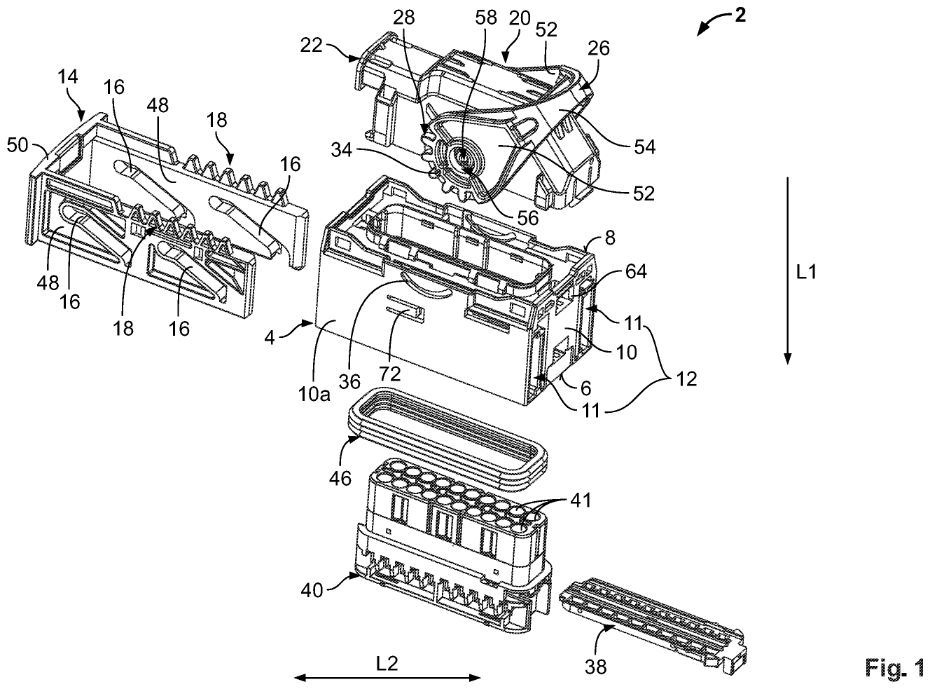

FIG. 1 shows an exemplary embodiment of an electrical connector assembly 2 according to the invention in an exploded side view. The electrical connector assembly 2 comprises a main housing 4 having a front face 6 (the lower face in FIG. 1), a rear face 8 (the upper face in FIG. 1) and sidewalls 10 between the front face 6 and the rear face 8. The sidewalls 10 can form an essentially rectangular integral frame defining opposite openings at the front face 6 and the rear face 8. The main housing 4 has an essentially rectangular shape. Further, the main housing 4 has two receptacles 11 adjacent to the longitudinal sidewalls 10a of the main housing 4.

The receptacles 11 form a guide 12, which is configured to receive a slider 14 having oblique grooves 16 and cam surfaces 18. The guide 12 receives the slider 14 at least in part and to guide the slider 14 in a lateral direction essentially parallel to the front face 6 and the rear face 8. The guide 12 can be comprised of a receptacle or receptacles having guide surfaces and being provided adjacent to the sidewalls 10 and extending in a longitudinal direction of the main housing 4.

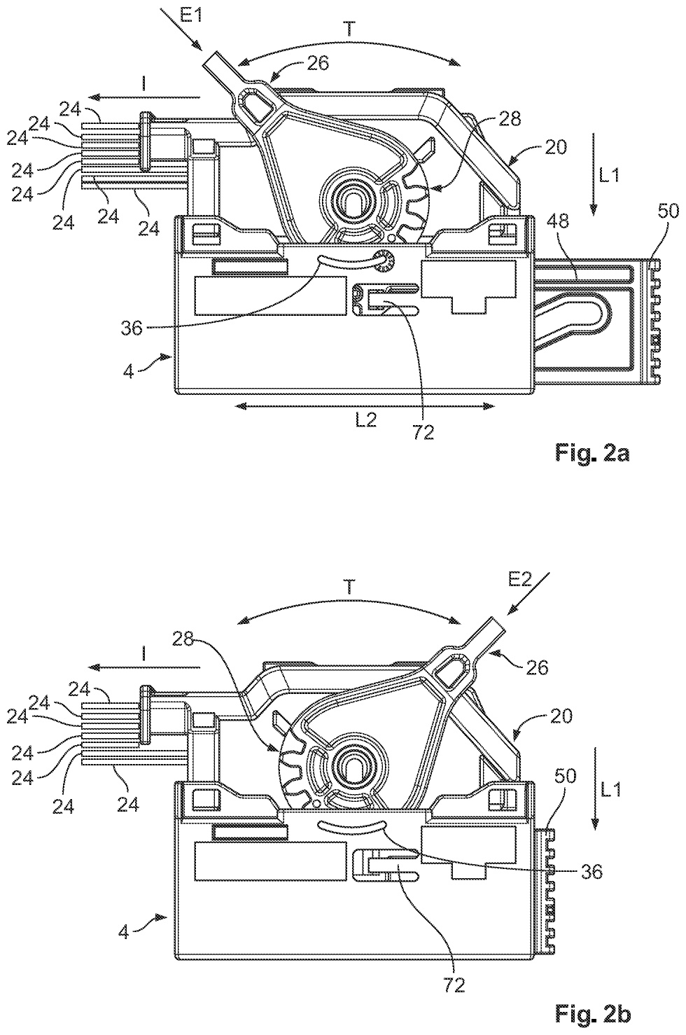

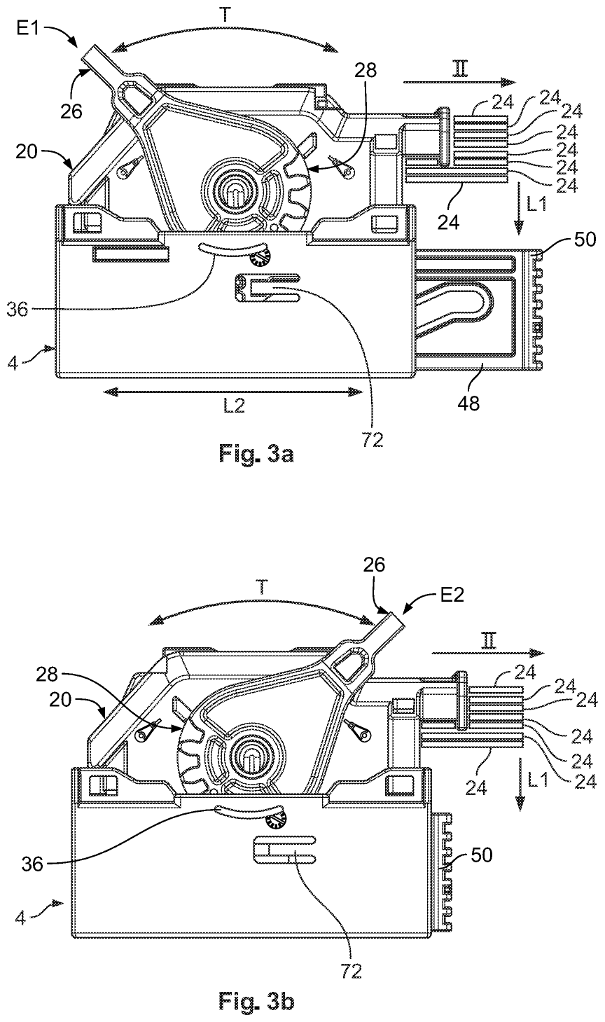

A cover 20 having an aperture 22 for at least one cable 24 is mountable to the rear face 8 of the main housing 4 in a first orientation and in a second orientation reverse to the first orientation (see e.g. FIG. 2a and FIG. 3a). The cover 20 can have a closed rear face and an open front face, the front face being connectable with the rear face 8 of the main housing 4. In an embodiment, the aperture 22 is provided at a lateral side of the cover 20. Other lateral sides of the cover 20 may be closed.

Reverting to FIG. 1, a lever 26 comprising a cam counter surface 28 is hinged to the cover 20, wherein the cam counter surface 28 is configured to cooperate with the cam surface 18 in order to translate the slider 14 upon tilting of the lever 26.

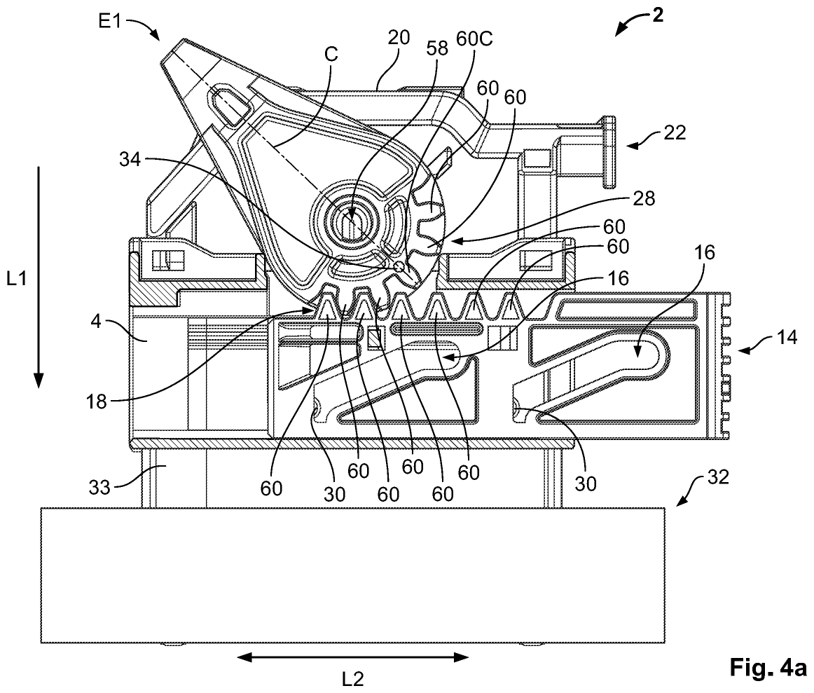

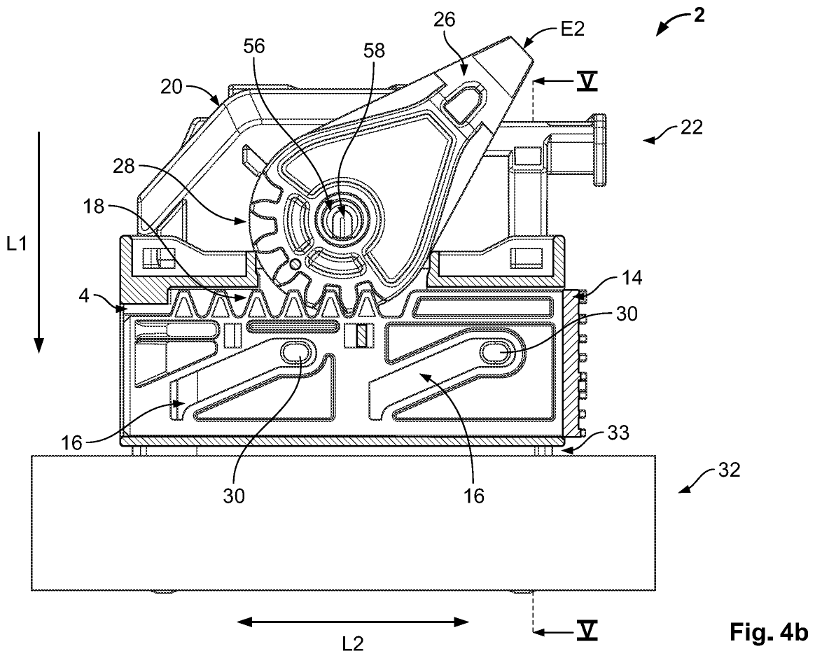

The oblique grooves 16 of the slider 14 are configured to cooperate with a mating element 30 of a socket 32 in order to move the electrical connector assembly 2 in a locking direction L1 and into engagement with the socket 32, the mating element 30 being provided as a projection at an outer face of a socket housing 33 (see FIG. 4a and FIG. 4b).

Reverting to FIG. 1, the lever 26 and the main housing 4 have a poka-yoke device, which is composed of a pin 34 connected to the lever 26 and a pin receiving guide 36 provided by the main housing 4.

The poka-yoke device prevents the lever 26 being pre-installed in a wrong position; the poka-yoke device established a pre-lock condition only when the lever 26 is tilted into a predetermined initial position. Thereby, it can be prevented that the lever 26 is pre-installed in a wrong initial position when, for example, the cover 20 is released from the main housing 4 in the first orientation, reversed and mounted onto the main housing 4 in the second orientation to alternate the dressing of the cable 24.

For example, the cover 20 could be mounted to the main housing 4 at one side, and the poka-yoke device prevents a connection at the other side when the lever 26 is not tilted into the predetermined initial position. In an embodiment, there is a gap between the cam counter surface 28 and the cam surface 18 when the cover 20 is not fully mounted to the main housing 4, such that the cam counter surface 28 and the cam surface 18 do not come into operative coupling. However, one can also envisage an embodiment of the present invention where the cover 20 is fully mounted to the housing 4, but the poka-yoke device prevents the cam counter surface 28 coming into operative coupling with the cam surface 18 when the lever 26 is not tilted into the predetermined initial position.

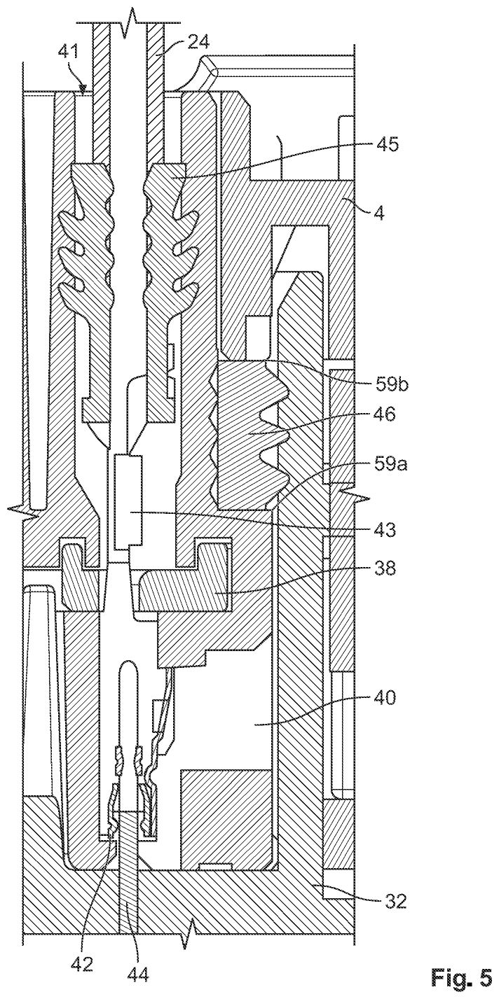

A retainer 38 is provided to hold a female connector housing 40 within the main housing 4. The female connector housing 40 comprises a plurality of slots 41. In said slots 41, female plug-in contact portions 42 are arranged that are connectable to a cable 24 via a terminal tab 43 and that are configured to receive male plug-in contact portions 44, wherein a cable seal 45 is provided to seal a gap between the cable 24 and the slot 41 and wherein a main seal 46 is provided to seal a gap between the female connector housing 40 and the main housing 4 (see FIG. 5). The main seal 46 can be formed as a continuous loop. In an embodiment, the retainer 38 is insertable into the main housing 4 such that opposing sidewalls 10 of the housing 4 support the retainer 38. The retainer 38 can have through-holes assigned to slots 41 of the female connector housing 40, wherein the female plug-in contact portions 44 are arranged in those slots 41.

As shown in FIG. 1, the slider 14 comprises two parallel legs 48 and a base 50 that connects the parallel legs 48 at one end. Each leg 48 comprises two oblique grooves 16 that are spaced from each other in a longitudinal direction L2 and a cam surface 18 that is provided at an edge facing towards the cover 20. The base 50 and the main housing 4 are configured such that the base 50 abuts at the main housing 4 when the legs 48 are completely slid into the receptacles 11. The lever 26 comprises two limbs 52 that are connected via a handle portion 54, wherein each limb 52 has a cam counter surface 28 and is formed with a bearing 56 configured to cooperate with a counter bearing 58 provided by the cover 20.

FIG. 2a shows a side view of the exemplary embodiment of the electrical connector assembly 2 in a pre-lock condition, in which the cover 20 is mounted to the main housing 4 and the cam counter surfaces 28 of the lever 26 are in operative coupling with the cam surfaces 18 of the slider 14. FIG. 2b shows a side view of the electrical connector assembly 2 in an end-lock condition. By actuation of the lever 26 in the pre-lock condition, the pre-lock condition turns into the end-lock condition. In the pre-lock condition, the lever 26 is in a first end position E1 in a tilting direction T; and in the end-lock condition, the lever 26 is in a second end position E2 in the tilting direction T, the first end position E1 and the second end position E2 being the two opposite end positions in the tilting direction T. After the pre-lock condition is appropriately established, tilting the lever 26 between the first end position E1 and the second end position E2 translates the slider 14. In FIG. 2a, the cover 20 is mounted in a first orientation that is the same as the orientation in FIG. 1. In the first orientation, cables 24 that pass through the aperture 22 of the cover 20 are dressed by the cover 20 into a first lateral direction I.

FIGS. 3a and 3b are similar to FIGS. 2a and 2b. FIG. 3a shows a side view of the exemplary embodiment of the electrical connector assembly 2 in the pre-lock condition and FIG. 3b shows a side view of the end-lock condition, the only difference being that the cover 20 is mounted to the main housing 4 in a second orientation, which is reverse to the first orientation. Thus, in FIGS. 3a and 3b, the cables 24 are dressed in a second lateral direction II that is opposite to the first lateral direction I. Notably, the first end position E1 corresponding to the pre-lock condition and the second end position E2 corresponding to the end-lock condition are the same as in FIGS. 2a and 2b, although the orientation of the cover 20 is reversed. This is because the slider 14 is insertable into the main housing 4 only from a predetermine side and, to achieve the desired leverage, the position of the lever 26 in the pre-lock condition must be opposite to the openings of the receptacles 11 for receiving the slider 14. In the pre-lock condition, the slider 14 is received in the guide 12 only in parts, wherein in the end-lock condition, the legs 48 of the slider 14 are completely received in the receptacles 11 and the base 50 of the slider 14 abuts against the main housing 4.

FIGS. 4a and 4b show side views of the exemplary embodiment of the electrical connector assembly 2 arranged on a fixed socket 32. FIG. 4a shows the pre-lock condition and FIG. 4b shows the end-lock condition. In FIGS. 4a and 4b, the main housing 4 is partially cut away to illustrate that the cam counter surface 28 of the lever 26 is in operative coupling with the cam surface 18 of the slider 14 and that the oblique grooves 16 of the slider 14 receive and guide mating elements 30 of the socket 32. By tilting the lever 26 from the first end position E1 in the pre-lock condition into the second end position E2, the pre-lock condition turns into the end-lock condition. Thereby, the lever 26 moves the slider 14 into the main housing 4 which movement is translated into a movement of the entire electrical connector assembly 2 in the locking direction L1 (i.e. towards the socket 32) by the interaction of the mating elements 30 with the oblique grooves 16. In the end-lock condition, the electrical connector assembly 2 is in engagement with the socket 32.

FIG. 5 is a section of a sectional view corresponding to the cross section indicated by V-V in FIG. 4b, and shows the electric plug connection that is established by the engagement of the electrical connector assembly 2 and the socket 32. That is, the male plug-in contact portion 44 provided by the socket 32 is in electric contact with the female plug-in contact portion 42 provided in a slot 41 of the female connector housing 40. The female plug-in contact portion 42 may be manufactured by cutting and bending a metal sheet to provide an elastic contact force when the male plug-in contact portion 44 is inserted. In the end-lock condition, the main seal 46 is at least partially compressed between a supporting shoulder 59a of the female connector housing 40 and a pressing shoulder 59b of the main housing 4.

Reverting to FIG. 4a, the cam surface 18 and the cam counter surface 28 are each formed by a plurality of teeth 60 that mesh with each other. In particular, the number of teeth 60 forming the cam surface 18 is six, the number of teeth 60 forming the cam counter surface 28 is five, and the teeth 60 of the cam counter surface 28 fit into the spaces between the teeth 60 of the cam surface 18. The teeth 60 of the cam counter surface 28 are arranged on a circular arc having the counter bearing 58 as a center. The teeth 60 of the cam surface 18 are arranged on a straight array that is tangential to the circular arc. Further, the pin 34 is provided next to the central tooth 60c of the cam counter surface 28. The central tooth 60c and the pin 34 are arranged on a center line C of the limb 52.

In an embodiment, the cam counter surface 28 comprises an uneven number of teeth 60 and the pin 34 is arranged at the central tooth.

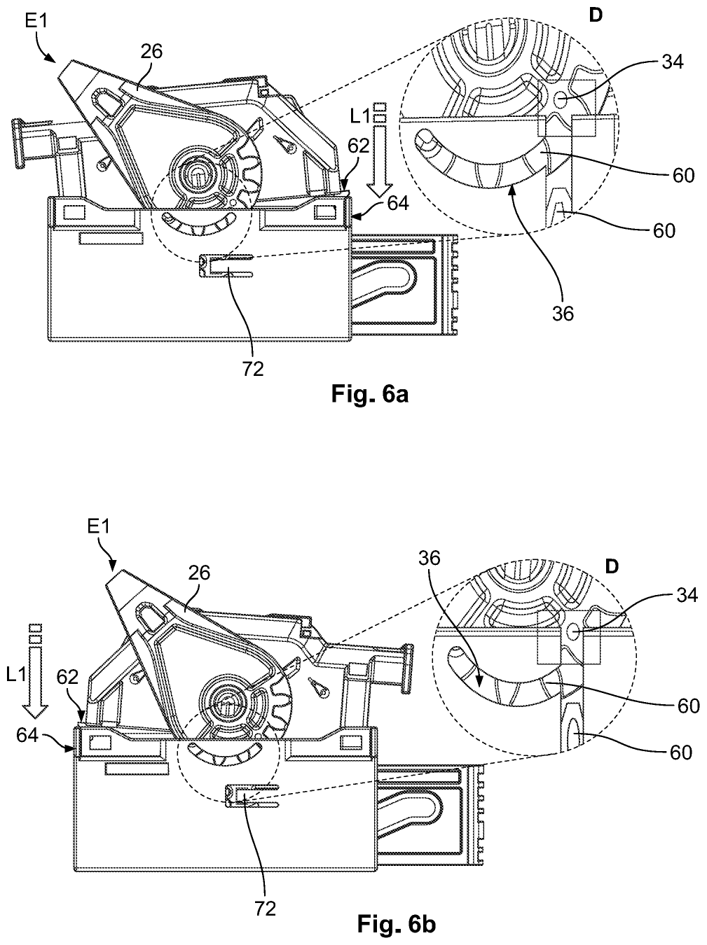

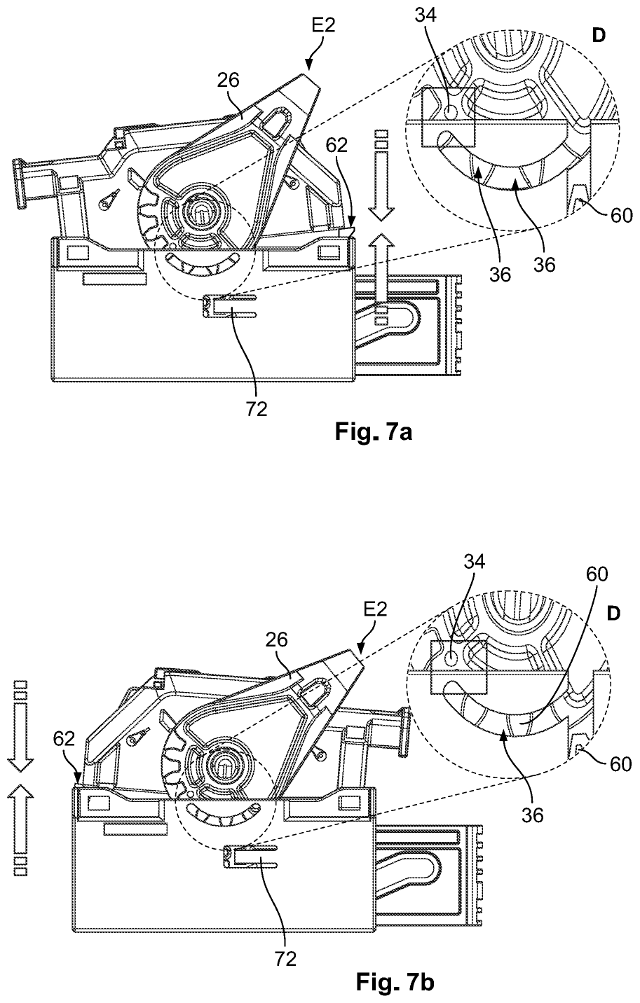

FIG. 6a and FIG. 6b show side views of the exemplary embodiment in the process of mounting the cover 20 to the rear side 8 of the main housing 4, the cover 20 being in the first orientation in FIG. 6a and in the second orientation in FIG. 6b, wherein the lever 26 is in the first end position E1 in both orientations of the cover 20. The cover 20 is provided with a locking projection 62 and the main housing 4 is provided with a corresponding locking recesses 64 to lock and unlock the cover 20 to the main housing 4 in both orientations. As shown by the enlarged detail in FIGS. 6a and 6b, the pin 34 enters into the pin receiving guide 36 when the lever 26 is in the first end position E1 and the cover 20 is mounted to the main housing 4 by pushing it against the rear side 8 of the main housing 4. On the other hand, as shown by the enlarged detail in FIGS. 7a and 7b, the pin 34 does not enter the pin receiving guide 36 when the lever 26 is initially in the second end position E2 and is not tilted to the first end position E1 in the process of mounting the cover 20 to the main housing 4. In the situation shown in FIGS. 7a and 7b, the cover 20 cannot be mounted to the main housing 4 and the cam counter surface 28 of the lever 26 cannot come into operative coupling with the cam surface 18 of the slider 14. The enlarged details in FIGS. 6a; 6b, 7a, 7b and 8 are marked with reference sign D.

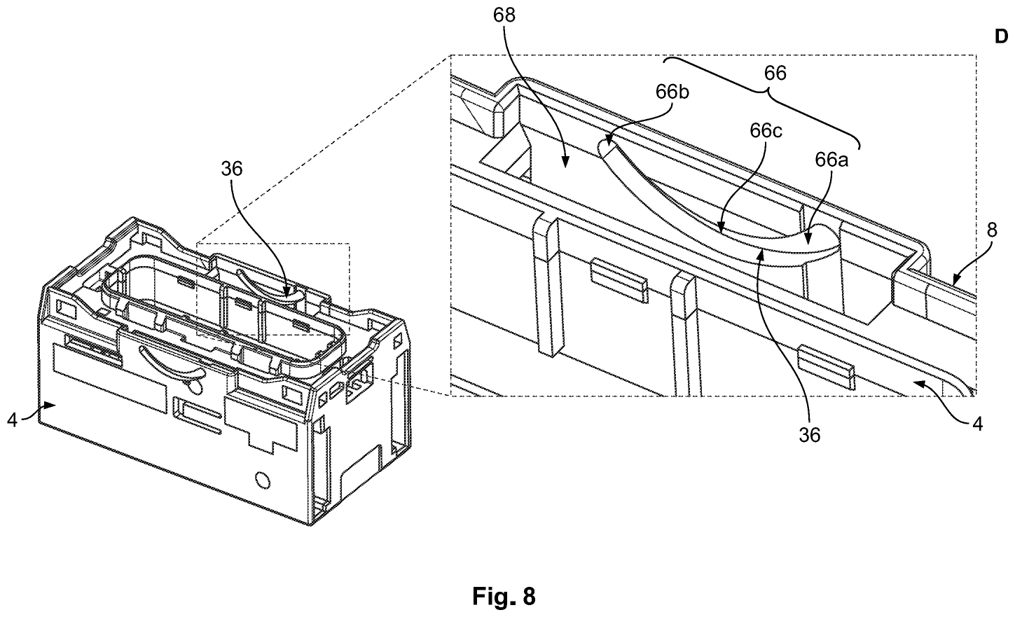

As illustrated by FIG. 8, the pin receiving guide 36 is formed by a curved slot 66 in the large sidewalls 10 of the main housing 4, wherein one end 66a of the curved slot 66 is partially open towards the rear face 8 of the main housing 4 and the other end 66b of the curved slot that is opposite the one end 66a with respect to a center 66c of the curved slot 66 is closed towards the rear face 8 of the main housing 4. That is, the curved slot 66 is—only at the one end 66a—at least partially connected to the rear face 8 of the main housing 4. In an embodiment, the pin receiving guide 36 is convex with respect to a pivotal point of the lever as a reference point. A lever receiving space 68 of the main housing 4 for receiving the free ends the limbs 52 and a length of the pin 34 are designed such that the pin 34 can only enter the curved slot 66 at the partially open end 66a, which end 66a is opposite to the other end 66b, the other end 66b being closer to the openings of the receptacles 11 for receiving the slider 14. The enlarged details in FIGS. 6a, 6b, 7a, 7b and 8 are marked with reference sign D.

In another embodiment, a center of the pin receiving guide 36 and the pivotal point of the lever 26 are aligned in the locking direction. In an embodiment, the pin 34 is provided on both limbs 52 and/or arranged on a centerline of the limb(s) 52. Thereby, leverage is enhanced.

To facilitate the understanding of the working principle of the poka-yoke device comprised of—in this exemplary embodiment—the pin 34 and the pin receiving guide 36, the sidewall 10 adjacent to the slider in FIGS. 6a, 6b, 7a and 7b is partially cut away in the enlarged details of those figures.

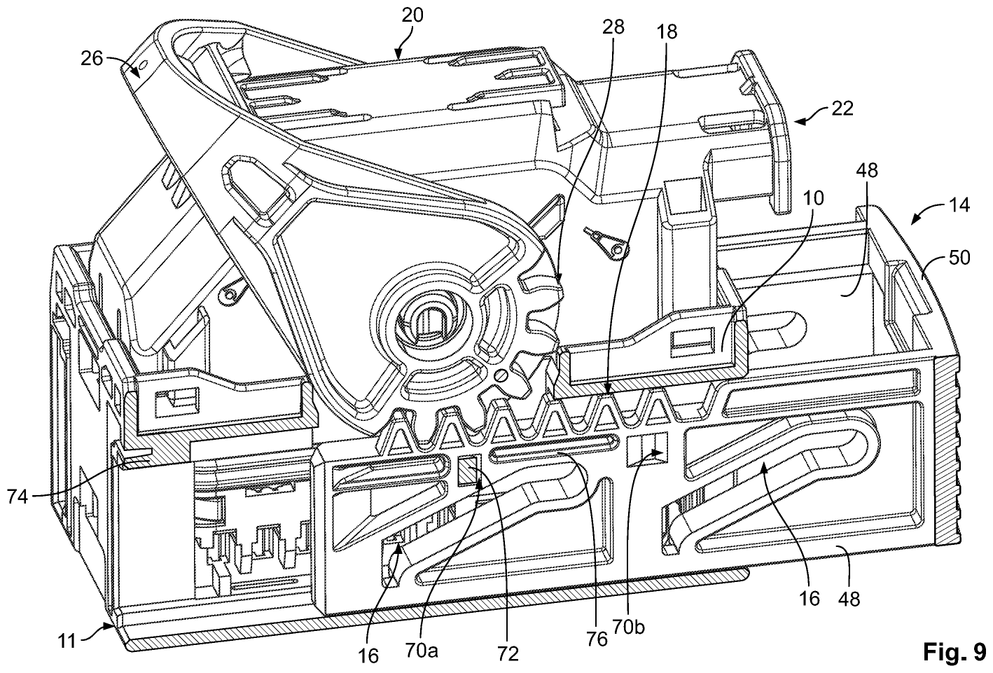

FIG. 9 shows a perspective side view of the exemplary embodiment in a state where a sidewall 10 of the main housing 4 is partially cut away to illustrate—for the pre-lock condition—the position of the slider 14 within the main housing 4 and the operative coupling between the cam surface 18 and the cam counter surface 28. Further, FIG. 9 illustrates that the slider 14 has a first notch 70a and a second notch 70b, wherein the first notch 70a is configured to receive a latch 72 of the main housing 4 when the slider 14 is inserted into the receptacles 11 for the first time, thereby holding the slider 14 in its position for establishing the pre-lock condition. Naturally, the slider 14 is inserted into the main housing 4 and held in its position for establishing the pre-lock condition before the cover 20 is mounted to the main housing 4. As illustrated in FIG. 9, the main housing 4 is provided with a shoulder 74 preventing the slider 14 being reversely inserted into the main housing 4. The latch 72 can be formed by, for example, cutting and bending a portion of the sidewall 10, the latching lug can be provided by a previous injection molding step.

The second notch 70b is configured to receive the latch 72 (fully illustrated e.g. in FIG. 1) of the main housing 4 to hold the slider 14 in its position corresponding to the end-lock condition, in which the legs 48 of the slider 14 are completely received in the receptacles 11 and the base 50 abuts against the main housing 4. The holding force exerted by the latch 72 when it is received in the first notch 70a and the second notch 70b respectively is overcome by tilting the lever 26 in the pre-lock condition or the end-lock condition respectively. Thus, after the pre-lock condition is established, the slider 14 is movable between these two positions corresponding to the pre-lock condition and the end-lock condition. If the latch 72 is exposed to unwanted and/or excessive bending forces, the slider could get pinched in the main housing 4, which would make the electric connector assembly malfunctioning. To avoid such unwanted and/or excessive bending forces that can easily happen when wrong loading is applied through the lever 26, the poka-yoke device prevents the lever 26 being pre-installed in a wrong initial position. Further, the slider 14 is provided with a guide surface 76 for guiding the latch 72 between the first notch 70a and the second notch 70b.

The electrical connector assembly 2 according to the embodiments described above has a reduced or minimized risk of being damaged by wrong loading applied by the lever 26.

The electrical plug connection includes the cable 24 electrically connected to a female plug-in contact portion 42 within the main housing 4, such as via the terminal tab 43, wherein the female plug-in contact portion 42 receives the male plug-in contact portion 44 of the socket 32, wherein the socket housing 33 has a mating element 30 received in the oblique groove 16 of the slider 14, wherein the oblique groove 16 is configured to cooperate with the mating element to move the electrical connector assembly 2 into an end-lock condition, in which the electrical connector assembly 2 is in engagement with the socket 32, and wherein the electrical connector assembly 2 is movable between a pre-lock condition, in which the cover 20 is mounted to the rear face 8 of the main housing 4 and the cam counter surface 28 is in operative coupling with the cam surface 18, and the end-lock condition by translating the slider 14 upon tilting of the lever 26.

What is claimed is:

1. An electrical connector assembly, comprising:
a main housing having a front face, a rear face, a pair of sidewalls between the front face and the rear face, and a guide;
a slider at least partially received in the guide, the slider having an oblique groove and a cam surface, the guide receives the slider at least in part and guides the slider in a lateral direction essentially parallel to the front face and the rear face;
a cover mountable to the rear face of the main housing and having an aperture for a cable; and
a lever hinged to the cover and having a cam counter surface, the cover is mounted to the rear face of the main housing and the cam counter surface is in operative coupling with the cam surface to translate the slider upon tilting of the lever in a pre-lock condition, the oblique groove cooperates with a mating element of a socket to move the electrical connector assembly in a locking direction essentially orthogonal to the front face and into engagement with the socket upon translation of the slider, the cover is mountable to the main housing in a first orientation in which the cover dresses the cable in a first lateral direction and the cover is mountable to the main housing in a second orientation reversely to the first orientation in which the cover dresses the cable in a second lateral direction reverse to the first lateral direction, the lever and the main housing have a poka-yoke device establishing the pre-lock condition only when the lever is tilted into a predetermined initial position.

2. The electrical connector assembly of claim 1, wherein the poka-yoke device has a pin connected to the lever and a pin receiving guide provided by the main housing.

3. The electrical connector assembly of claim 2, wherein the pin enters the pin receiving guide when the lever is tilted to a first end position in a tilting direction, the pin does not enter the pin receiving guide when the lever is tilted to a second end position opposite to the first end position in the tilting direction.

4. The electrical connector assembly of claim 1, further comprising a retainer supported by the main housing to hold a female connector housing provided within the main housing.

5. The electrical connector assembly of claim 4, wherein the female connector housing has a female plug-in contact portion receiving a male plug-in contact portion of the socket.

6. The electrical connector assembly of claim 5, further comprising a main seal provided in the main housing to seal a gap between the female connector housing and the sidewalls of the main housing.

7. The electrical connector assembly of claim 1, wherein the main housing has an essentially rectangular shape with a pair of large side walls and a pair of small side walls.

8. The electrical connector assembly of claim 7, wherein the slider has a pair of parallel legs extending in a longitudinal direction of the main housing, the parallel legs each have the cam surface and the oblique groove.

9. The electrical connector assembly of claim 8, wherein the slider has a base connecting the parallel legs at an end, the base abuts an outer side of one of the small side walls when the parallel legs are received in the main housing.

10. The electrical connector assembly of claim 2, wherein the lever has a pair of parallel limbs connected by a handle portion, each of the parallel limbs is hinged to the cover.

11. The electrical connector assembly of claim 10, wherein each of the parallel limbs has a bearing cooperating with a counter bearing on the cover.

12. The electrical connector assembly of claim 2, wherein the cam surface and the cam counter surface each have a plurality of teeth that mesh with each other.

13. The electrical connector assembly of claim 1, wherein the slider has a notch and, in an end-lock condition in which the slider is slid into the main housing by tilting the lever from the predetermined initial position into a final position, the notch receives a latch of one of the sidewalls of the main housing.

14. The electrical connector assembly of claim 1, wherein the guide has a shoulder preventing the slider from being inserted into the guide in a reverse direction.

15. The electrical connector assembly of claim 2, wherein the pin receiving guide is formed by a curved slot that is at least partially open toward the rear face at an end and closed at an opposite end.

16. The electrical connector assembly of claim 11, wherein a center of the pin receiving guide, the bearing, and the counter bearing are aligned in the locking direction.

17. The electrical connector assembly of claim 10, wherein the pin is disposed on both of the limbs.

18. The electrical connector assembly of claim 10, wherein the pin is arranged on a center line of one of the limbs.

19. The electrical connector assembly of claim 12, wherein the cam counter surface has an uneven number of teeth and the pin is arranged next to a central tooth.

20. An electrical plug connection, comprising:
a socket having a male plug-in contact portion in a socket housing;
an electrical connector assembly including:
a main housing having a front face, a rear face, a pair of sidewalls between the front face and the rear face, and a guide;
a slider at least partially received in the guide, the slider having an oblique groove and a cam surface, the guide receives the slider at least in part and guides the slider in a lateral direction essentially parallel to the front face and the rear face;
a cover mountable to the rear face of the main housing and having an aperture for a cable; and
a lever hinged to the cover and having a cam counter surface, the cover is mounted to the rear face of the main housing and the cam counter surface is in operative coupling with the cam surface to translate the slider upon tilting of the lever in a pre-lock condition, the oblique groove cooperates with the socket to move the electrical connector assembly in a locking direction essentially orthogonal to the front face and into engagement with the socket upon translation of the slider, the oblique groove cooperates with the mating element to move the electrical connector assembly into an end-lock condition in which the electrical connector assembly is in engagement with the socket, the cover is mountable to the main housing in a first orientation in which the cover dresses the cable in a first lateral direction and the cover is mountable to the main housing in a second orientation reversely to the first orientation in which the cover dresses the cable in a second lateral direction reverse to the first lateral direction, the lever and the main housing have a poka-yoke device establishing the pre-lock condition only when the lever is tilted into a predetermined initial position; and
a cable electrically connected to a female plug-in contact portion within the main housing, the female plug-in contact portion receives the male plug-in contact portion of the socket.
